(19) United States
(12) Patent Application Publication
(10) Pub. No.: US 2015/0239286 A1
(43) Pub. Date: Aug. 27, 2015

(54) Wheel Center Cap and Method Related Thereto

(71) Applicant: Flixrims, LLC, St. Thomas, VI (US)

(72) Inventor: Nicole Boswell-Horstmeyer, Miami Beach, FL (US)

(73) Assignee: FLIXRIMS, LLC, St. Thomas, VI (US)

(21) Appl. No.: 14/631,468

(22) Filed: Feb. 25, 2015

Related U.S. Application Data
(60) Provisional application No. 61/944,406, filed on Feb. 25, 2014.

(51) Int. Cl. B60B 7/00

(52) U.S. Cl. CPC B60B 7/0053; B60B 7/0013; B60B 2310/318; B60B 2310/228; B60B 2900/572

(57) ABSTRACT

Disclosed is an invention in the field of automotive wheels and center caps. The present invention particularly relates to a wheel center cap and method of production thereto. In particular, a wheel center cap containing pre-drilled cavities drilled into the wheel center cap to contain decorative materials of a desired design, wherein an affixing step is utilized in connection with affixing said decorative materials to a wheel center cap in a manner which allows for utilization of point-back, or non-flat-back, decorative materials without creating additional height or weight from the use of an additional resin or support layer for affixing the decorative materials.

### CROSS-REFERENCE TO RELATED APPLICATIONS

This application is a non-provisional application which claims benefit under 35 USC §119(e) to U.S. Provisional Application Ser. No. 61/944,406 filed Feb. 25, 2014, entitled “CENTER CAP FOR VEHICLE WHEEL,” which is incorporated herein in its entirety.

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### TECHNICAL FIELD

The present disclosure relates in general to the field of vehicle wheels. In particular, the present disclosure relates to a decorative and functional center cap connected to a vehicle wheel assembly and related methods of making.

### STATEMENT OF FEDERALLY FUNDED RESEARCH

None.

### BACKGROUND OF THE DISCLOSURE

Vehicle wheels have long utilized ornamental outer coverings for providing a decorative surface to the exposed outer surface of vehicle wheels. Outer coverings offer design flexibility in that various configurations may be used to cover a single style wheel. Certain aspects of outer coverings have included the utilization of a center cap to cover the central hub aperture of an associated wheel. In many instances the center cap contains ornamental or decorative features, ranging from logo displays to protruded features such as spikes or spokes.

Decorative materials, such as glass crystals have also been incorporated into various items ranging from household items and fixtures to clothing apparel and accessories. These crystal or glass elements, such as rhinestones or other glass stones, provide optical effects and aesthetic qualities. Popularized in hip hop culture, and known as “bling”, referring to flashy, ostentatious or elaborate jewelry and ornamented accessories that are carried, worn or installed, such as cell phones or clothing accessories, many of these decorative glass elements have also been incorporated into various vehicle components, including license plate frames, body panels, door handles, emblems and decals, as well as interior features such as gear shifts, knobs, mirrors and upholstery.

There have been attempts to add such decorative glass elements to vehicle wheels. However, most of these decorative materials are flat-backed glass elements which are affixed using glues, adhesives or other fasteners. These flat-backed glass elements are less aesthetically pleasing and are not optimized for providing reflective features of many three-dimensional (3-D), or point-back glass elements. Affixed glass elements are further subject to wear, breakage, and removal through contact with objects. Point-back glass elements are cut for maximizing brilliance of the crystal element. Chatons, which are diamond cut point-back glass crystals or rhinestones, are able to exhibit a greater level of brilliance when properly featured.

While it is known that such point-back decorative glass elements may be arranged on a carrier plate featuring an adhesive layer wherein a cover plate is provided, limitations exist regarding the durability of the affixed glass elements. Further efforts to provide a carrier plate with an intermediate layer made of a resin, where in the glass elements are embedded on the carrier plate, after which an artificial resin is applied to the elements to affix them. However, these three-layer (carrier plate, intermediate layer, and resin) are not feasible due to the weight of the assembly. In addition, the stone elements lose a substantial component of their optical effects due to the resin's refraction index.

WO 2006/074860 describes a rubber material that is poured into a casting mold, whereupon decoration elements are laid in the not yet cured rubber, the decoration element height being greater than the rubber layer thickness. The decoration elements rest on the casting mold. After at least partial curing of the rubber layer, further decoration elements can be scattered on, before a resin layer is poured over decoration elements and rubber layer. After curing of rubber layer and resin layer, they are removed from the casting mold and the rubber layer can be drawn off of the resin layer. A decoration element is therefore to be provided, from whose surface the decorative parts protrude like a relief. At least one rubber layer and at least one resin layer are therefore always to be provided, which results in an increased production expenditure.

Other methods include producing injection-molded decoration articles having decorative materials arranged in the injection-molded materials, wherein the decorative materials are applied to a carrier film and the carrier film having the decorative materials is then inserted in an injection mold and the decorative materials are then extrusion coated, which, is limited by only allowing complete extrusion coating in the injection-molding machine.

Furthermore, casting decorative materials into layers of resin layer is known, wherein a first base layer of resin or other material is positioned for then adding decorative materials, which may be partially immersed in the first base layer. However, in order to seal such decorative materials, another layer of liquid casting resin would then be required to be poured over the decorative objects. Subsequently, still a further surface layer may then poured over these resin layers.

Other methods include providing a composite material plate, which provide for a carrier layer, a resin layer, and a support layer (see US 20130129961).

As they apply to wheels and wheel center caps, the limitations of the art include the requirement of two or more layers to adequately secure and protect the glass elements or decorative materials, provide for weight and thickness which exceed a reasonable weight in consideration of the affixing means of the wheel cap. The use of the techniques known in the art are not feasible for maintaining the light weight necessary for a wheel center cap that is attached to a wheel. In order to address the weight restrictions of the current steps, the strength and durability of the affixing and resin layer become ineffective in maintaining the durability necessary to withstand the impacts endured during vehicular and wheel use.

It is therefore desired to have a wheel center cap which adequately features ornamental glass elements in a lightweight, durable and functional manner without adversely affecting the protective and aesthetic finish of the wheel cap.

### SUMMARY OF THE DISCLOSURE

The present disclosure addresses failings in the art by providing a process used to seal real or decorative stones or glass elements in accessories used in the automotive industry. In one aspect, the assembly of such stones or glass elements occur on a wheel and the center cap of the wheel. The present disclosure involves two steps to secure the decorative materials and then protect the decorative materials from damage and wear, including but not limited to, weather, vibration, ancillary impact, cleaning, and general wear and tear.

The present disclosure provides for a wheel center cap containing cavities drilled into the cap to contain decorative materials of a desired design, wherein an affixing step is utilized in connection with affixing said decorative materials to a wheel center cap in a manner which allows for utilization of a point-back decorative element without creating additional height or weight by using an additional resin or support layer for affixing the decorative materials.

The present disclosure may further provide methods for affixing and sealing decorative materials on a center wheel cap, wherein the wheel cap has cavities drilled in accordance with the preferred design motif for the decorative materials.

The present disclosure enables the production of center wheel caps containing affixed point-back decorative materials having an affixing step followed by a protective resin enclosing the decorative materials to prevent damage or breakage of the decorative materials.

The present disclosure further provides a method of producing a center wheel cap having cavities drilled into the surface of the center wheel cap to specified arrangements and dimensions to affix decorative materials; where a protective resin layer is then applied to the surface of the wheel cap having the affixed decorative materials, allowing for the protective resin layer to cover completely the decorative materials, thus providing a smooth, flat, and transparent surface having enhance optical characteristics.

The present disclosure further allows for a lower profile or depth of the center cap containing decorative materials to attach to the centrally located aperture of a wheel wherein the center cap is lightweight enough to ensure proper attachment and use as intended.

It is therefore an object of the present disclosure to provide a wheel center cap having affixed decorative materials, comprising: a wheel center cap having an outer surface; one or more pre-drilled cavities on the outer surface of the wheel center cap; one or more decorative materials affixed to said one or more pre-drilled cavities using an adhesive; and a protective layer covering said one or more decorative materials. It is another object to provide a wheel center cap made from a material selected from the group consisting of: steel, aluminum, alloy, plastic, or a polymer. The outer surface of the wheel center cap may be recessed from a lip on the circumference of said wheel center cap.

It is another object to have a decorative materials attached to the wheel center cap, wherein the decorative materials are point-back decorative materials. The decorative materials may be gems, gemstones, lead crystal, glass, polished glass crystals, unpolished glass crystals, faceted crystal, faceted glass, wood, beads, plastics, stones, painted objects, gold metallic particles.

It is another object of the present disclosure to utilize adhesive selected from: two-component epoxy adhesives, polyurethane adhesives, cyanacrylate glues, UV glues, silicone glues, and dispersion glues, contact glues, plastic glues, Acrylonitrile butadiene styrene (ABS), Acrylonitrile Styrene Acrylate (ASA), Cellulose Acetate (CA), Engineered Plastic (EP), Polyamide are semi-crystalline polymers (PA), Polycarbonate (PC), Polyethylene (PE), Polyethylene terephthalate (PET), Phenol formaldehyde resin-synthetic polymers (PF), Polyisobutylene (PIB), Poly(methyl methacrylate) (PMMA), Polyoxymethylene (POM), Polypropylene (PP), Polystyrene (PS), Polytetrafluoroethylene (PTFE), Polyvinylidene chloride (PVDC), Styrene Acrylonitrile (SAN), Silicone (SI), and Unsaturated Polyester (UP).

The adhesive may comprise a two-component adhesive, such as a liquid epoxy-prepolymer (CAS #25068-38-6) mixed with polyaminoamide or tetraethylenepentamine.

The protective layer may comprise a transparent epoxy, a liquid resin, or a two-part liquid epoxy-prepolymer (CAS #25068-38-6) mixed with polyaminoamide or tetraethylenepentamine.

It is another object of the present disclosure to provide a protective layer to cover the external surface of the decorative material in order to preserve and protect the decorative materials from damage during operation. The protective layer may cover the external surface of the decorative material by at least 1 mm.

It is another object of the present disclosure to provide a method for affixing decorative materials to a wheel center cap comprising: pre-drilling one or more cavities into said center wheel cap; affixing one or more decorative materials into the one or more cavities; and applying a protective layer over the affixed decorative materials, wherein said protective layer covers the external surface of said decorative materials, which may further comprise point-back decorative materials such as gems, gemstones, lead crystal, glass, polished glass crystals, unpolished glass crystals, faceted crystal, faceted glass, wood, beads, plastics, stones, painted objects, gold metallic particles.

The affixing step may include affixing one or more decorative materials further comprising using a two-part adhesive, wherein a first-part expoxy-prepolymer is mixed with a second part tetraethylenepentamine.

It is another object of the present disclosure to provide a wheel center cap having affixed decorative materials, comprising: a wheel center cap having decorative materials affixed to the outer surface; a protective layer covering said one or more decorative materials; and said wheel center cap further removably attached to a wheel assembly, such as by one or more O-ring housings; threads; or a plurality of flexible fingers protruding substantially orthogonal to the body of said wheel center cap for attachment to the wheel. Particularly, the wheel center cap's weight allows for removable attachment to said wheel assembly without becoming removed during operation. During attachment and use, the wheel center cap may be configured to cover the lug nut housing portion of the wheel assembly, thus protecting the lug nuts from damage during operation, or in the event the lug nuts are displaced or become removed from the hub bolt during operation. The center wheel cap would ensure the lug nuts will not fall away from the wheel assembly, and would replace other lug nut locking systems.

### BRIEF DESCRIPTION OF THE DRAWINGS

The foregoing and other objects, features, and advantages of the disclosure will be apparent from the following description of embodiments as illustrated in the accompanying figures and drawings. Additional tables are present throughout the disclosure.

FIG. 1A depicts a schematic of a wheel center cap showing wheel cap cavity design for purposes of housing various decorative materials. In this instance, the design features certain logo and brand characteristics, where indicated.

FIG. 1B depicts a side elevational view of a wheel center cap of the present invention which covers the central hub aperture of an associated wheel.

FIG. 2 depicts an exploded schematic view of the wheel center cap of FIG. 1A, showing wheel cap cavity design for purposes of housing various decorative materials and featuring certain logo and brand characteristics, where indicated.

FIG. 3 depicts an exploded side elevational view of a wheel center cap of the present invention with prepared cavities for point back decorative elements.

FIG. 4 depicts a side perspective view of a wheel center cap of the present invention with prepared cavities for point back decorative elements, with elements being presented for insertion into the cavities.

FIG. 5A depicts an exploded side elevational view of a wheel center cap having adhesive applied to the cavities with the decorative materials being lowered into the designated cavities formed within the center cap.

FIG. 5B depicts an exploded side elevational view of a wheel center cap having adhesive applied to the point back decorative materials, with the decorative materials being lowered into the designated cavities formed within the center cap.

FIG. 6 depicts an exploded side elevational view of a wheel center cap having decorative elements affixed and covered with a protective layer.

### DETAILED DESCRIPTION OF THE DISCLOSURE

While the making and using of various embodiments of the present disclosure are discussed in detail below, it should be appreciated that the present disclosure provides many applicable inventive concepts that can be embodied in a wide variety of specific contexts, goods, or services. The specific embodiments discussed herein are merely illustrative of specific ways to make and use the disclosure and do not delimit the scope of the disclosure.

All publications and patent applications mentioned in the specification are indicative of the level of skill of those skilled in the art to which this disclosure pertains. All publications and patent applications are herein incorporated by reference to the same extent as if each individual publication or patent application was specifically and individually indicated to be incorporated by reference.

The present disclosure will now be described more fully hereinafter with reference to the accompanying figures and drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, compositions, processes, or systems. The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

For the purposes of the present disclosure “decorative materials” includes, but is not limited to: gems, gemstones, lead crystal and glass pieces, polished and unpolished glass crystals, faceted crystal and glass pieces, wood, beads, plastics, stones, painted objects, gold and other such various metallic particles metal compositions of various shapes, forms, sizes, and types.

Decorative materials may include SWAROVSKI® elements and crystals. Swarovski elements are created by the Swarovski company, and they are primarily made from lead crystal, which is glass with lead added to it to produce a higher degree of shine. Current Swarovski rhinestones typically feature between 8 and 14 facets, and their precision cutting method creates stones that have an enhanced brilliance and reflective quality Rhinestones may also be called Austrian crystals and feature a wide variety in choices. Decorative materials come in varying shapes and sizes, and may further include chatons, round stones, rhinestones, crystal mesh, fancy stones, metal ornaments, glass transfers, crystal fabric, crystal trans-fabric, crystal glaze, plastic trimmings and metal trimmings. Chatons, fancy stones, and the like. Point-back decorative materials, such as chatons, fancy stones, and SFP chatons, create high quality optical effects, known as brilliance. Flat-backed decorative materials have less optical effects. In order to maximize brilliance, the use of point-back decorative materials is preferred.

Another type of decorative material, Czech rhinestones or glass elements, refer to a type of decorative material that is made from pure glass or from lead crystal. These rhinestones have up to eight facets, with one large, flat central facet surrounded by smaller facets. This type of cut creates a dull stone when compared to the Swarovski rhinestones, which are considered the standard in the art. Czech rhinestones also have less lead in the glass, resulting in a less sparkling gem.

Decorative materials come in various sizes, and are often sized in accordance with the following Table 1. Sizes may even be larger than the below table.

TABLE 1
Non-exhaustive examples of decorative material sizes.

| Size in Millimeters | SS Size |
|---|---|
| 1.5-1.7 mm | 4 SS |
| 1.7-1.9 mm | 5 SS |
| 1.9-2.1 mm | 6 SS |
| 2.1-2.3 mm | 7 SS |
| 2.3-2.5 mm | 8 SS |
| 2.5-2.7 mm | 9 SS |
| 2.7-2.9 mm | 10 SS |
| 2.9-3.0 mm | 11 SS |
| 3.0-3.2 mm | 12 SS |
| 3.4-3.6 mm | 14 SS |
| 3.6-3.8 mm | 15 SS |
| 3.8-4.0 mm | 16 SS |
| 4.2-4.4 mm | 18 SS |
| 4.6-4.8 mm | 20 SS |
| 4.9-5.1 mm | 22 SS |
| 5.3-5.4 mm | 24 SS |
| 5.6-5.7 mm | 26 SS |
| 5.9-6.1 mm | 28 SS |
| 6.3-6.5 mm | 30 SS |
| 6.7-6.9 mm | 32 SS |
| 7.1-7.3 mm | 34 SS |
| 8.4-8.7 mm | 40 SS |
| 8.9-9.2 mm | 42 SS |
| 9.5-9.9 mm | 44 SS |
| 10.2-10.5 mm | 46 SS |
| 10.9-11.3 mm | 48 SS |

The present disclosure utilizes a wheel center cap which may be manufactured from various materials, such as steel, aluminum, alloys, plastics, or other polymers. The wheels and wheel caps may further be brushed, painted, powder coated, chromed or otherwise treated for aesthetic and protective purposes. The center cap may be customized to cover all or part of a wheel's central aperture, including the lug nuts and other assemblies, as required by the design of the wheel. In another embodiment, the wheel center cap covers the lug nuts.

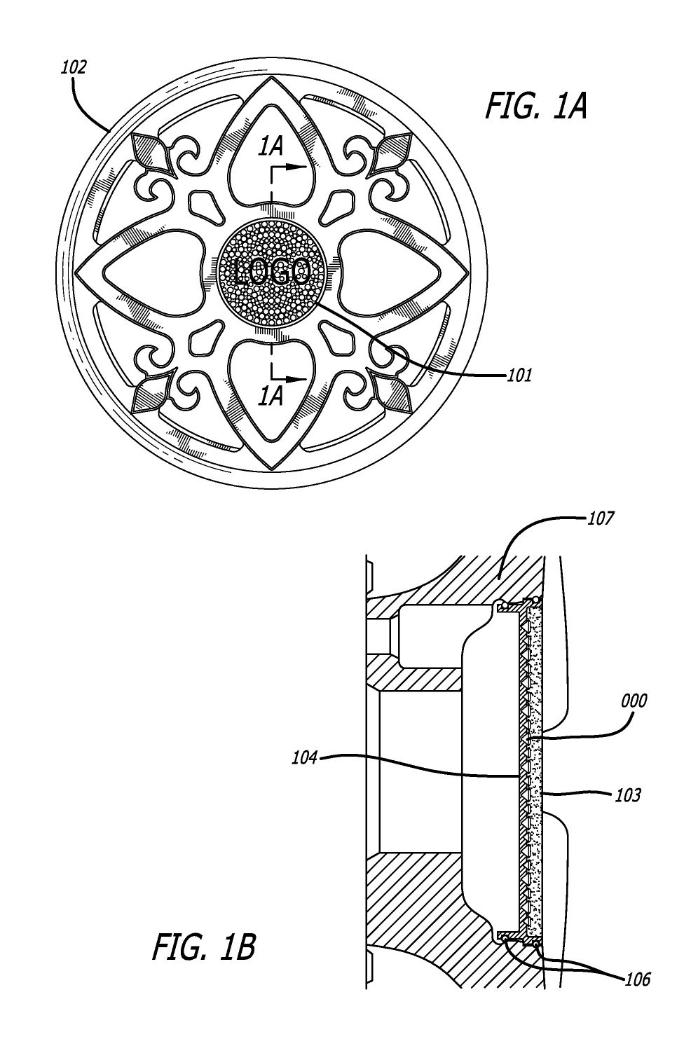

Turning to FIG. 1A of the present disclosure, a wheel assembly 102 comprises a wheel center cap 101 affixed to the central aperture of the wheel assembly 101. The wheel center cap may be affixed to the wheel by screwing mechanism, O-ring configurations, or other known attachment means. FIG. 1B provides and exploded view of the cross section of a wheel center cap of the present disclosure, wherein the wheel center cap 104 is attached and held using a double-O-ring configuration 106 to attached the wheel center cap 104 to the wheel assembly 107. Pre-drilled cavities are located in the wheel center cap 104, in which decorative elements 000 are affixed. A protective layer 103 is then utilized to cover the decorative elements 000 within the pre-drilled cavities of the wheel center cap 104.

Wheel center caps of varying sizes may be addressed, wherein wheel cavities or hubs are of varying size and thickness. In one embodiment, the center cap may be designed to cover the entire central aperture of a wheel configuration, including the lug nut(s), wherein the outer edge of the wheel cap provides for a depth which allows for decorative materials and other materials to be placed inside the cavity portion at a depth necessary for the decorative materials to be seated evenly with the outer edge of the wheel center cap. In another embodiment, the center cap is placed solely over the hub aperture, leaving the lug nuts exposed such as with FIG. 1B. Various configurations of wheel center cap are considered by the present disclosure, and any reference to a particular wheel center cap is not to be considered limiting. The surface of the cavity portion of the wheel center cap has a minimum thickness required for cavities to be formed on the surface to house the decorative materials in the preferred design motifs, wherein the top portion, or crown of the materials do not extend beyond the outer edge, or lip, of the wheel center cap, thus allowing for a flat, smooth surface, or even slightly below the outer rim of the wheel center cap if preferred, while covering the decorative material in its entirety.

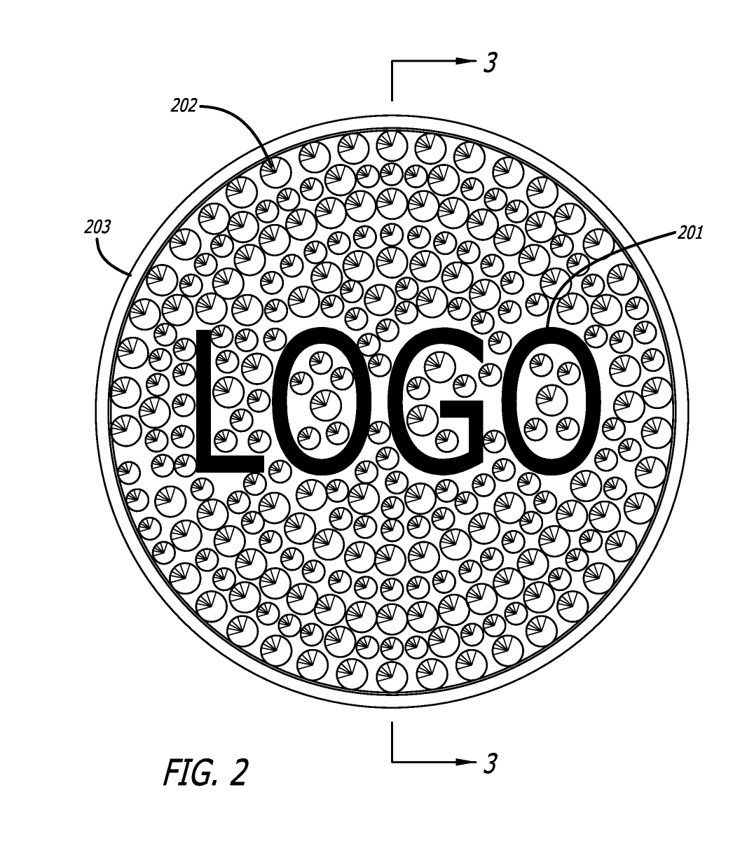

Turning to FIG. 2, an exploded view of the wheel center cap 203 is provided. Cavities 202 are pre-drilled into the wheel center cap 203, and the desired arrangement is prepared for inserting the decorative materials. The cavities 202 may be arranged to provide a logo 201 or other design not made by the decorative materials, such as by engraving, forging, decal, or other means.

Correctly shaped cavities are essential for affixing any point back decorative element onto carrier surface. Experience has shown that the most common reason for crystals becoming detached is that the cavity was drilled with the wrong angle. For example, the optimal cavity for the XILION® Chaton has an angle of 90°-93°. The optimal amount of adhesive covers the whole foiling up to the girdle of the decorative material. This protects the decorative material from environmental influences and from chemicals. The cavity should have the same maximum diameter and size as the crystal plus a slightly additional amount, such as 0.1 mm. In one embodiment, the cavities should be bored or drilled with a Twist drill or NC drill to an angle of 90°-93° in. Additional sizes available are then determined in accordance with Table 1, for purposes of achieving the appropriate depth of the cavity. In a preferred embodiment, the cavity should not pierce the wheel center cap.

With particularly large crystals with a prominent girdle, it is advisable to use an additional countersinking process in pre-drilling the cavity. For decorative materials manufactured by casting, an extra indentation at the bottom of the cavity can be drilled to avoid a rounded tip and therefore preventing the tip of the crystal from touching the bottom of the cavity.

In another aspect of the present disclosure, the center cap may be affixed to the wheel with the use of O-ring assemblies to fit within the central aperture of the wheel such as shown in FIG. 1B. Alternatively, the center cap may be screwed onto the wheel assembly. In yet another embodiment, the center cap may be attached using a plurality of flexible fingers protruding substantially orthogonal to the body of the wheel cap for attachment to the wheel through the abutment of the flexible fingers to the side walls of the central aperture of the wheel, thus snapping the wheel cap into place.

For the purposes of this disclosure, the body portion of the center wheel cap is designed to have a cavity portion, wherein the outer surface of the body portion of the center wheel cap is capable of having various cavities pre-milled, drilled, molded, extruded, forged, or otherwise prepared, for affixing decorative materials to the outer surface of the wheel cap, all of which are shall be referred to as “pre-drilled” for the purpose of the present disclosure. In one embodiment, cavities are pre-drilled into the center wheel cap in accordance with a design anticipating the attachment of decorative elements. Designs may vary and may further include logos or other designs incorporated into the array of decorative materials. The dimensions of the pre-drilled cavities may be determined using known calculations for the point-back decorative materials. These pre-drilled cavities allow for the placement of the decorative materials for affixing. Most decorative materials, such as chatons, fancy stones, or other point-back glass elements, have dropdown measurements for allowing: cavity depth, recommended cavity angle, maximum diameter of the cavity, and countersink depth. These allow for the proper dimension for the pre-milling or drilling of the cavity, and thus collectively comprise a pre-drilled cavity.

In one embodiment, an adhesive is applied to the pre-drilled cavities, wherein the decorative materials are then placed within the applicable cavities. In another embodiment, the point-back portions of the decorative materials are themselves applied an adhesive material for then placing into the applicable pre-drilled cavities. In yet another embodiment, both the pre-drilled cavity and the point-back portion of the decorative material are provided a layer of the same adhesive. In another embodiment, the two layers may be synergistic adhesive layers, such as two-part epoxy resins, providing increased bonding when brought together. Adhesives tend to shrink as they harden. There will be a greater amount of shrinkage if the wrong glue has been chosen, it will harden under the wrong conditions or if there is a wrong sized cavity (too much space around the decorative material). The tension thus created can damage the foiling and the decorative material may even detach.

For the purpose of the present disclosure, adhesives include commonly known adhesives suitable for different materials. In a preferred embodiment, an adhesive known as CG 500-35 (A+B) Two-Component Epoxy Resin Glue, is utilized. Other examples of applicable adhesives are other two-component epoxy glues, polyurethane glues, cyanacrylate glues, UV glues, silicone glues, and dispersion or contact glues. Synthetic adhesives may also be used, such as the following plastics: Acrylonitrile butadiene styrene (ABS), Acrylonitrile Styrene Acrylate (ASA), Cellulose Acetate (CA), Engineered Plastic (EP), Polyamide are semi-crystalline polymers (PA), Polycarbonate (PC), Polyethylene (PE), Polyethylene terephthalate (PET), Phenol formaldehyde resin-synthetic polymers (PF), Polyisobutylene (PIB), Poly(methyl methacrylate) (PMMA), Polyoxymethylene (POM), Polypropylene (PP), Polystyrene (PS), Polytetrafluoroethylene, or teflon (PTFE), Polyvinylidene chloride (PVDC), Styrene Acrylonitrile (SAN), Silicone (SI), and Unsaturated Polyester (UP).

TABLE 2
Common adhesives suitable for varying decorative materials.

| | | Two-Component | | | Polyurethane | | | | | | | | | |
|---|---|---|---|---|---|---|---|---|---|---|---|---|---|---|
| | | Epoxy Resin Glues | | | Glues | | Cyanacrylate | | UV | | | | | |
| | | | Uhu | | | Scotch | Glues | | Glues | | Silicone | Dispersion- & | | |
| | | CG | Plus | | | Weld | UHU | Cyber- | Photo- | Photo- | Glues | Contact Glues | | |
| | | 500- | endfest | Araldite | Araldite | DP | Instant | bond | bond | bond | Elastosil | | Chris- | Bostik |
| | | 35 | 300 | 2011 | 2026 | 610 | Adhesive | 2999 | GB 368 | GB 345 | N2199 | Konstruvit | anne | 1475 |
| Inor- | Crystal | • | | | • | • | | | • | • | • | | | |
| ganic | Glass | • | | | • | • | | | • | • | • | | | |
| Mate- | Ceramics | • | • | • | | | | | | | • | | | |
| rials | Stone | • | • | • | • | | | | | | • | | | |
| Met- | Aluminium | • | • | • | | | | | | | • | | | |
| als | Brass | • | • | • | | | | | | | • | | | |
| | Silver | • | • | • | | | | | | | • | | | |
| | Steel | • | • | • | | | | | | | • | | | |
| Glu- | PC | • | • | • | • | • | • | • | | | | | | |
| able | PS | • | | | • | | • | | | | | | | |
| Syn- | PVC/ABS | • | • | • | • | • | • | • | | | • | | | |
| thetic | Rubber | • | | | • | | • | • | | | | | | |
| Mate- | | | | | | | | | | | | | | |
| rials | | | | | | | | | | | | | | |
| Or- | Paper | • | | | | | • | • | | | • | • | • | • |
| ganic | Cork | • | | | | | | | | | • | • | • | • |
| Mate- | Wood | • | • | • | | | | | | | • | • | • | • |
| rials | Textiles | | | | | • | | | | | | • | • | • |

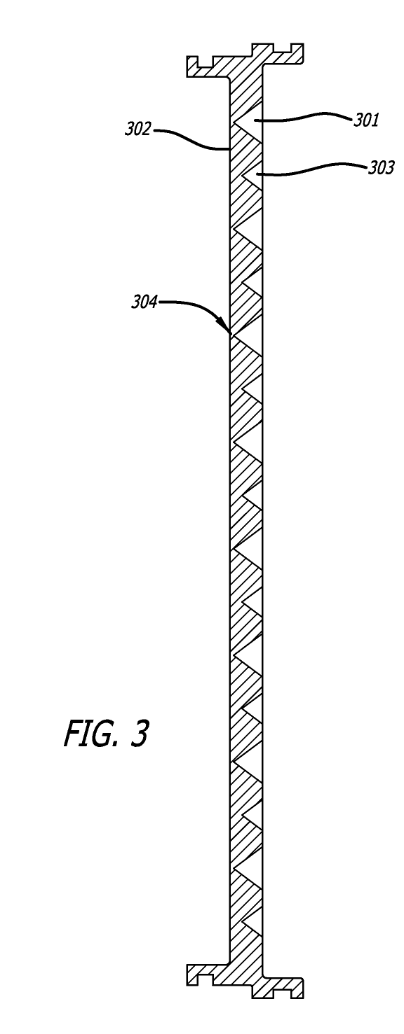

In one embodiment, the exterior portion of the wheel cap may be designed to accommodate various decorative materials, including the decorative materials defined herein, wherein cavities are drilled to desired depths and angles required to ensure the cavities do not penetrate the bottom, inner service of the wheel cap, but are at the desired depth and angle to accommodate the decorative material. FIG. 3 provides a cross-section view of the various cavities drilled into the center cap to accommodate the decorative materials. The finished wheel cap may be drilled to have cavities which will then allow for attachment of the decorative materials using an affixing step, followed by a “protective layer” comprising a transparent hardening material, such as crystal gloss enamels, epoxies, or other surface protectant known in the art. By drilling the cavities to allow for placement of decorative materials, the present disclosure allows for reduced profiles of point-back crystal or glass elements, which have previously required an affixing layer of resin or fastener, which would increase the required depth of the assembly. Further, the increased weight of the resin or fastener, along with the required layer of protective layer, will often cause the wheel center cap to have too much weight. The cavities further allow for the reduced weight of the center cap, by removing portions of the cap and reducing the need for an affixing resin or fastener, but will still allow for snapping or affixing the center wheel cap to the wheel assembly using very small amounts of adhesive and at a lower profile than decorative materials sunk into an epoxy affixing layer on top of a surface. These previous methods of attaching point-back or non-flat-back decorative materials are weight prohibitive and problematic for center wheel caps absent special center cap affixing means, such as locks or glues.

Referencing FIG. 3, the distal features of the wheel center cap 302 provide cavities for O-ring assemblies, which then affix the center cap to the wheel. The various dimensions of the cavities, 301, 303 are shown as pre-drilled into the center cap. The decorative materials may vary in size and depth, requiring varying cavity sizes and dimensions with allowable clearance to not perforate the center wheel cap 304. In one embodiment, the finished wheel cap may further be coated, polished, painted, or otherwise finished following the formation of the cavities.

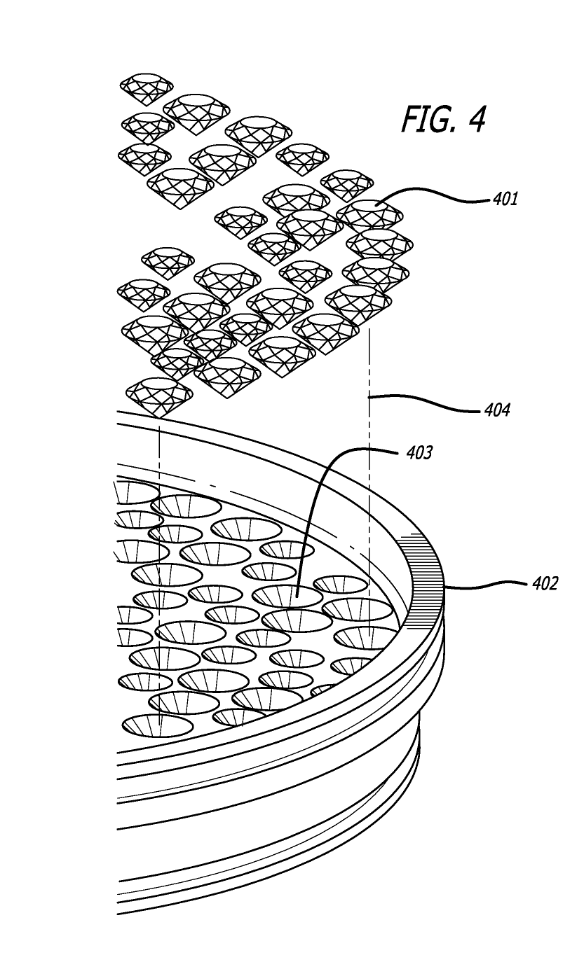

Referencing FIG. 4, the decorative materials of the desired shape, optical qualities, and color 401, are positioned over the applicable pre-drilled cavity 403 for insertion 404 of the decorative material onto the cavity 403. FIG. 4 further exemplifies the cavities presented on the exterior circumference of the center cap 402, in one embodiment having two O-ring assemblies, in order to affix the center cap to the wheel.

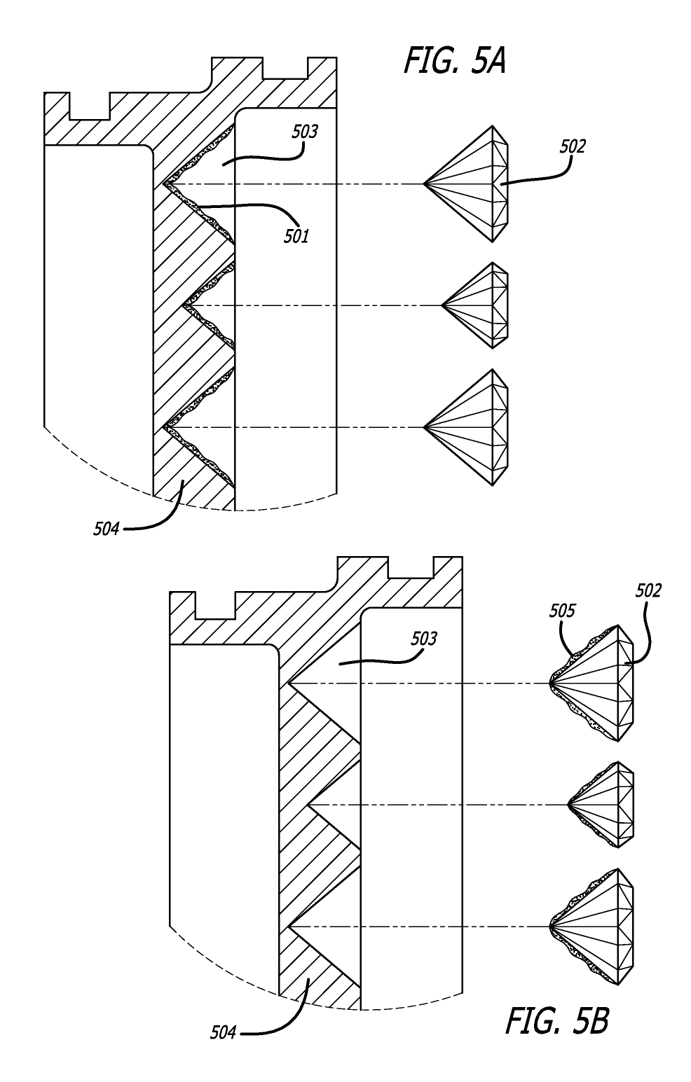

Turning to FIGS. 5A and 5B, the decorative materials 502 may be affixed to the wheel center cap 504 using an affixing step, such an exemplary affixing step as set forth in Example 1, below and is then allowed a required time to harden or cure. In one embodiment, the affixing step may include the application of an affixing layer 501 to the inside of the pre-drilled cavity 503. In another embodiment, the affixing layer 505 is added to the point-back portion of the decorative material 502 for affixing the decorative material 502 to the cavity 503 pre-drilled into the wheel center cap 504.

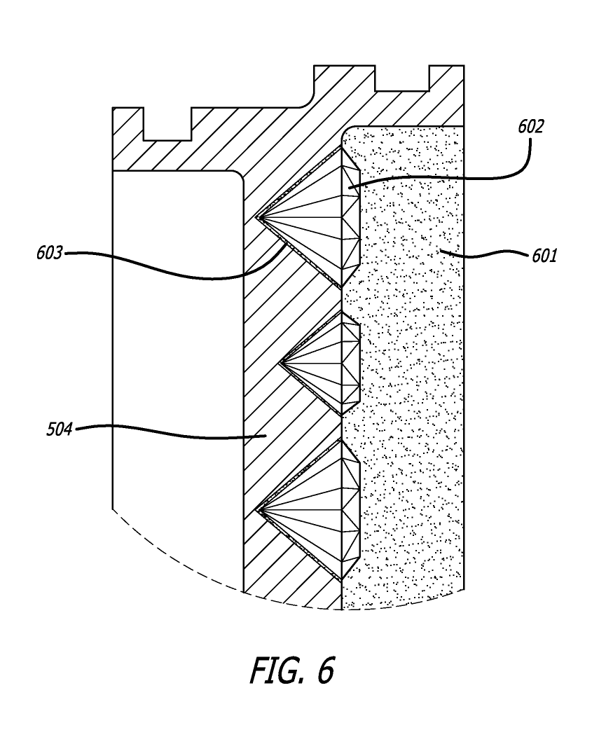

FIG. 6 exemplifies the finished center caps with decorative materials 602 affixed with a small layer of adhesive 603. The protective layer 601, which may comprise a liquid resin, epoxy, or other liquid transparent material, is then applied. The material 601 is then allowed to harden and cure, thus providing enclosed decorative materials retaining a desired optical quality, while preserved against damage and wear, including but not limited to weather, vibration, ancillary impact, and general wear and tear. The thickness of the protective layer 601 may be adjusted as required in order to adequately preserve the decorative materials 602 while limiting the thickness, and weight, of the protective layer 601. The protective layer 602 thickness may be even with the wheel center cap 504, or the protective layer 602 may be slightly below the outer lip of the wheel center cap 504.

Those skilled in the art will recognize that the methods and articles of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

Example 1, below provides an illustrative embodiment of the present disclosure. While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

### Example

### Example 1

### Setting, Sealing and Curing of Decorative Materials within a Wheel Center Cap

See the design set forth in FIG. 2 with cavities pre-drilled specifically for the shape of the selected decorative materials, which will vary according to the shape and size of the desired decorative materials. It is understood that various epoxy systems may be used for the purposes of the present disclosure, including hardeners and transparent epoxies, resins, or other layers. For this Example 1, a specific liquid epoxy-prepolymer (Crystal Gloss A,) made by SWRAROVSKI AG (CAS #25068-38-6) (Epoxy Resin A), is a two-component epoxy, is mixed with polyaminoamide or tetraethylenepentamine (Crystal Gloss B), made by SWAROVSKI AG (CAS #112-57-2 (tetraethylenepentamine)), (the Hardener B), having a ratio of 1:0.33 ratio or 30 mL of Epoxy Resin (A) with 10 mL of Hardener (B). Stir for 2 minutes. The mixture is provided rest for 15 minutes or until no air bubbles remain. Using syringe, pull up 5 mL of mixture, press out air bubbles with tip of syringe facing upward. The resulting compound is applied in each cavity to ensure that each cavity is ⅔ full of compound. Excess compound is removed in the event the cavity is too full. The decorative materials are then set and the affixing compound mixture is allowed to completely harden. Once the decorative materials are secure/affixed and do not move in the cavities, the decorative material surfaces are cleaned with a clean, dry cloth to remove any residue from placement tools or finger prints. See FIG. 6 for an exemplar of affixed decorative materials 602.

Upon the hardening of the affixing mixture, Hardener B is then mixed with Epoxy Resin A in a 3:1 (Epoxy Resin A to Hardener B) ratio. In the current example, Hardener B=10 mL, Epoxy Resin A=30 mL, Total=40 mL. Hardener B is poured first. The resulting mixture is stirred for 2 minutes and then let sit 20 minutes for air bubbles to dissipate. The resulting mixture is then poured onto the outer surface of the wheel cap making sure stones are completely covered and compound is even at the top surface. The wheel cap is then set on a flat, and if possible vibrating surface, to let compound even out and help bubbles dissipate. Depending on ambient conditions, compound may have varying times (up to 24 hours) to completely harden. See FIG. 6 for the sealed decorative materials with the protective layer 601.

Those skilled in the art will recognize that the methods and articles of the present disclosure may be implemented in many manners and as such are not to be limited by the foregoing exemplary embodiments and example. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad combinations of the decorative materials are possible in achieving the functions, features, interfaces and preferences described herein. Moreover, the scope of the present disclosure covers conventionally known manners for carrying out the described features and functions, as well as those variations and modifications that may be made herein as would be understood by those skilled in the art now and hereafter.

Furthermore, the embodiments of methods presented and described as Example 1 in this disclosure are provided by way of example in order to provide a more complete understanding of the present disclosure. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and processes described above to obtain a result that remains within the scope of the methods described in this disclosure.

What is claimed is:

1. A wheel center cap having affixed decorative materials, comprising:
a. a wheel center cap having an outer surface;
b. one or more pre-drilled cavities on the outer surface of the wheel center cap;
c. one or more decorative materials affixed to said one or more pre-drilled cavities using an adhesive; and
d. a protective layer covering said one or more decorative materials.

2. The wheel center cap of claim 1, wherein said wheel center cap is comprised of a material selected from the group consisting of: steel, aluminum, alloy, plastic, or a polymer.

3. The wheel center cap of claim 1, wherein said outer surface is recessed from a lip on the circumference of said wheel center cap.

4. The wheel center cap of claim 1, wherein the decorative materials are point-back decorative materials.

5. The wheel center cap of claim 1, wherein the decorative materials are selected from the group consisting of: gems, gemstones, lead crystal, glass, polished glass crystals, unpolished glass crystals, faceted crystal, faceted glass, wood, beads, plastics, stones, painted objects, gold metallic particles.

6. The wheel center cap of claim 1, wherein said adhesive is selected from the group consisting of: two-component epoxy adhesive, polyurethane adhesive, cyanacrylate glues, UV glues, silicone glues, and dispersion glues, contact glues, plastic glues, Acrylonitrile butadiene styrene (ABS), Acrylonitrile Styrene Acrylate (ASA), Cellulose Acetate (CA), Engineered Plastic (EP), Polyamide are semi-crystalline polymers (PA), Polycarbonate (PC), Polyethylene (PE), Polyethylene terephthalate (PET), Phenol formaldehyde resin-synthetic polymers (PF), Polyisobutylene (PIB), Poly(methyl methacrylate) (PMMA), Polyoxymethylene (POM), Polypropylene (PP), Polystyrene (PS), Polytetrafluoroethylene (PTFE), Polyvinylidene chloride (PVDC), Styrene Acrylonitrile (SAN), Silicone (SI), and Unsaturated Polyester (UP).

7. The wheel center cap of claim 1, wherein said adhesive comprises a two-component adhesive.

8. The wheel center cap of claim 1, wherein said adhesive comprises a liquid epoxy-prepolymer (CAS #25068-38-6) mixed with polyaminoamide or tetraethylenepentamine.

9. The wheel center cap of claim 8, wherein said two-component adhesive is prepared at a ratio of about 1.0:0.33 first liquid epoxy prepolymer (CAS #25068-38-6) to polyaminoamide.

10. The wheel center cap of claim 8, wherein said two-component adhesive is prepared at a ratio of about 1.0:0.33 first liquid epoxy prepolymer (CAS #25068-38-6) to tetraethylenepentamine.

11. The wheel center cap of claim 1, wherein said protective layer comprises a transparent epoxy.

12. The wheel center cap of claim 1, wherein said protective layer comprises a liquid resin.

13. The wheel center cap of claim 1, wherein said protective layer comprises a liquid epoxy-prepolymer (CAS #25068-38-6) mixed with polyaminoamide or tetraethylenepentamine.

14. The wheel center cap of claim 13, wherein said protective layer is prepared at a ratio of about 3:1 first liquid epoxy prepolymer (CAS #25068-38-6) to polyaminoamide.

15. The wheel center cap of claim 13, wherein said protective layer is prepared at a ratio of about 3:1 first liquid epoxy prepolymer (CAS #25068-38-6) to tetraethylenepentamine.

16. The wheel center cap of claim 1, wherein said protective layer covers the external surface of the decorative material.

17. The wheel center cap of claim 1, wherein said protective layer covers the external surface of the decorative material by at least 1 mm.

18. A method for affixing decorative materials to a wheel center cap comprising:
a. pre-drilling one or more cavities into said center wheel cap;
b. affixing one or more decorative materials into said one or more cavities; and
c. applying a protective layer over said affixed decorative materials, wherein said protective layer covers the external surface of said decorative materials.

19. The method of claim 18, wherein said decorative materials comprise point-back decorative materials.

20. The method of claim 18, wherein said decorative materials are selected from the group consisting of: gems, gemstones, lead crystal, glass, polished glass crystals, unpolished glass crystals, faceted crystal, faceted glass, wood, beads, plastics, stones, painted objects, gold metallic particles.

21. The method of claim 18, wherein affixing said one or more decorative materials further comprising using a two-part adhesive, wherein a first-part expoxy-prepolymer is mixed with a second part tetraethylenepentamine.

22. The method of claim 18, wherein applying said protective layer further comprises pouring said protective layer over the external portion of said one or more decorative materials.

23. A wheel center cap having affixed decorative materials, comprising:
a. a wheel center cap having decorative materials affixed to the outer surface;
b. a protective layer covering said one or more decorative materials; and
c. said wheel center cap further removably attached to a wheel assembly.

24. The wheel center cap having affixed decorative materials of claim 23, wherein said wheel center cap is removably attached to said wheel assembly by an attachment selected from the group consisting of: one or more O-ring housings; threads; or a plurality of flexible fingers protruding substantially orthogonal to the body of said wheel center cap for attachment to the wheel.

25. The wheel center cap of claim 23, wherein said wheel cap's weight allows for removable attachment to said wheel assembly without becoming removed during operation.
